(19) United States
(12) Patent Application Publication
(10) Pub. No.: US 2018/0118073 A1
(43) Pub. Date: May 3, 2018

(54) AUTOMOBILE MAT

(71) Applicant: William Benjamin Green, Hixson, TN (US)

(72) Inventor: William Benjamin Green, Hixson, TN (US)

(21) Appl. No.: 15/794,696

(22) Filed: Oct. 26, 2017

Related U.S. Application Data
(60) Provisional application No. 62/413,884, filed on Oct. 27, 2016.

(51) Int. Cl. B60N 3/04; B32B 7/10; B32B 5/02; B32B 3/30; B32B 27/12

(52) U.S. Cl. CPC B60N 3/048; B32B 7/10; B32B 5/02; B32B 2605/003; B32B 27/12; B60N 3/044; B32B 2471/04; B32B 3/30

(57) ABSTRACT

A removable and machine-washable automobile mat assembly, wherein the assembly having an upper mat and a lower mat and an interlocking means of attachment configured to removably attach the upper and lower mats.

### CROSS-REFERENCE TO RELATED APPLICATION

This application claims priority under 35 U.S.C. § 119(e) from U.S. Provisional Application Ser. No. 62/413,884, filed Oct. 27, 2016.

### FIELD OF INVENTION

The present disclosure relates generally to an automobile mat assembly and, in particular, to a removable, machine-washable and interchangeable automobile mat assembly having an interlocking means of attachment.

### BACKGROUND OF THE INVENTION

Carpet is normally installed in a vehicle to cover a floor surface or a floor bed of the vehicle. A removable automobile mat is a comfortable and luxurious way to protect the carpet from unnecessary wear and tear caused by friction and debris introduced into the vehicle by shoes, feet, kids, pets, weather, and cargo. A conventional automobile mat often includes a single-layer fibrous material having a non-fibrous backing where the most common way of cleaning the mat includes pressure washing and air-drying. This cleaning process is time consuming, requires pressure-washing equipment, utilizes excessive amounts of water, environmentally unfriendly cleaning agents, and causes unnecessary wear and tear on the mat. Additionally, when a section of a conventional automobile mat becomes worn or stained, it must be fully replaced.

Space constraints of brick and mortar retailers limit options offered to consumers due to the weight and size of existing automobile mats. Additionally, these retailers have reduced their assortments to a limited offering of ‘trim-able’ rubber automobile mats, few design options, and still fewer carpet automobile mat selections. Online retailers incur significant shipping and inventory management costs due to the size and weight of the conventional (single-layered carpeted) automobile mats currently on the market. The present solution allows brick and mortar retailers and online retailers to offer expanded assortments of colors, patterns, designs, and licensed logos more effectively and at a significantly lower cost than conventional automobile mats with similar design/imagery; thus, creating value and opportunity for retailers and customers. Reducing the weight of replacement parts to just the fibrous portion of the mat assembly improves supply-chain and logistics efficiencies, reduces costs, reduces resource consumption, and reduces manufacturing/supply-chain emissions.

Example implementations of the present invention solve these problems by providing a removable automobile mat assembly that can be stably attached, easily separated for cleaning, and easily cleaned by removing a detachable fibrous portion and washing it in a standard household or commercial washing machine. The present solution allows retailers to stock many variations of color and texture of the automobile mat assembly of the present invention, in particular, the fibrous portion, allowing consumers the ability to mix and match with options that are lightweight, easy to ship, and customizable to customer needs and wants such that only a portion of the mat assembly need be replaced if it becomes worn, or if the user desires a different color, pattern, or design. Example implementations of the present invention provide a solution that allows the fibrous portion, the most difficult part to clean, to be detached and removed for convenient cleaning in a household washing machine, eliminating the need for special care of the automobile mat such as pressure washing or replacement of the mat altogether. Example implementations of the present invention provide a unique means for stably attaching the assembly, in a manner that will withstand the wear and tear of foot traffic, is less likely to wear-down over time, and in a manner, that eliminates the need for certain adhesives that will degrade with multiple washings. No other product exists that provides a similar capability, functionality, product stability and integrity, convenience, or sustainability for the consumer.

### SUMMARY OF THE INVENTION

Embodiments of the present invention are generally directed to a removable automobile mat.

The present disclosure thus includes, without limitation, the following example implementations.

Some embodiments provide a removable automobile mat assembly comprising an upper mat having a top surface, a bottom surface, a first side edge, a second side edge, a third side edge, and a fourth side edge, wherein said first side edge further comprises an upper mat interlocking means; a lower mat having a top surface, a bottom surface, a first side edge, a second side edge, a third side edge, and a fourth side edge, wherein said first side edge comprises a lower mat interlocking means; and wherein the upper mat and lower mat are configured to be removably attached to one another.

In some embodiments, the upper mat interlocking means comprises a press-stud.

In some embodiments, the lower mat interlocking means comprises a press-stud receptacle.

In some embodiments, the upper mat interlocking means comprises a press-stud receptacle.

In some embodiments, the lower mat interlocking means comprises a press-stud.

In some embodiments, the top surface of the lower mat further comprises a plurality of grooves.

In some embodiments, the top surface of the upper mat comprises machine washable fiber.

In some embodiments, the top surface of the upper mat further comprises machine washable polymer fiber.

In some embodiments, the top surface of the upper mat further comprises washable natural fiber.

In some embodiments, the top surface of the lower mat is formed having a recess along a perimeter of the first side edge, the second side edge, the third side edge and the fourth side edge.

In some embodiments, the bottom surface of the upper mat is comprised of semi-flexible material.

In some embodiments, the bottom surface of the lower mat is comprised of semi-flexible material.

Some embodiments provide an automobile mat comprising a mat having a top surface, a bottom surface, a first side edge, a second side edge, a third side edge, and a fourth side edge, wherein said first side edge further comprises an interlocking means.

In some embodiments, the interlocking means comprises a press-stud.

In some embodiments, the interlocking means comprises a press-stud receptacle.

In some embodiments, the top surface of the mat comprises machine washable fiber.

In some embodiments, the top surface of the mat is comprised of semi-flexible material.

Some example implementations provide a removable automobile mat assembly kit comprising an upper mat having a top surface, a bottom surface, a first side edge, a second side edge, a third side edge, and a fourth side edge, wherein said first side edge further comprises an upper mat interlocking means; and a lower mat having an top surface, a bottom surface, a first side edge, a second side edge, a third side edge, and a fourth side edge, wherein said first side edge comprises a lower mat interlocking means.

In some embodiments, the upper mat and lower mat are configured to be removably attached to one another.

In some embodiments, the upper mat interlocking means comprises a press-stud.

In some embodiments, the lower mat interlocking means comprises a press-stud receptacle.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as intended, namely to be combinable, unless the context of the disclosure clearly dictates otherwise.

It will therefore be appreciated that this brief summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE FIGURES

Having thus described the disclosure in the foregoing general terms, reference will now be made to the accompanying drawings, which are not necessarily drawn to scale, and wherein:

FIG. 1 is a top left exploded isometric view of a removable automobile mat in accordance with example implementations of the present disclosure;

FIG. 2 is a top left isometric view of the mat assembly with the upper and lower mats partially lifted apart from the first side edge in accordance with example implementations of the present disclosure;

FIG. 3 is a zoomed-in detailed view of the first side edge of the upper and lower mats in accordance with example implementations of the present disclosure;

FIG. 4 is a zoomed-in detail view of the front left corner of the lower mat in accordance with example implementations of the present disclosure;

FIG. 5 is a top left isometric view of the mat assembly in use in a vehicle with the upper mat partially lifted from the front left corner in accordance with example implementations of the present disclosure; and

FIG. 6 is a top isometric view looking from the front side of the automobile mat in accordance with example implementations of the present disclosure.

### DETAILED DESCRIPTION OF THE INVENTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference to something as being a first, second or the like should not be construed to imply a particular order. Also, for example, reference may be made herein to quantitative measures, values, relationships or the like (e.g., planar, coplanar, perpendicular). Unless otherwise stated, any one or more, if not all, of these may be absolute or approximate to account for acceptable variations that may occur, such as those due to engineering tolerances or the like. Like reference numerals refer to like elements throughout.

Example implementations of the present disclosure are directed to removable automobile mat. The removable automobile mat includes a unique interlocking system that secures a fibrous layer and an additional layer together improve the consumer's ability to conveniently and thoroughly clean the fibrous layer by detaching fibrous layer from the additional layer.

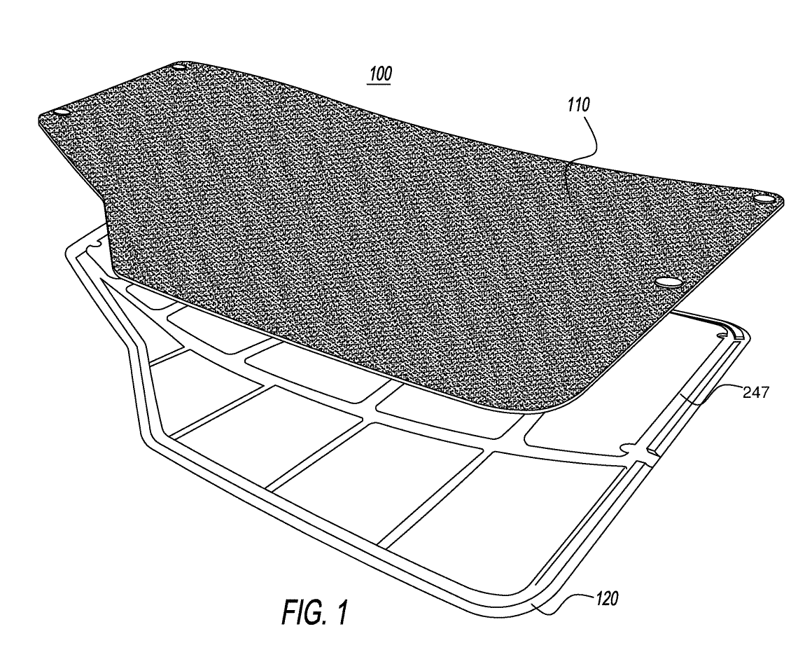

FIG. 1 illustrates a removable automobile mat assembly 100 according to some example implementations of the present disclosure. As shown, the removable automobile mat assembly 100 is generally composed of an upper mat 110 and a lower mat 120, according to various example implementations of the present disclosure. The upper mat 110 and the lower mat 120 of FIG. 1 may be detachably aligned in a functioning relationship.

The removable automobile mat assembly 100 may be substantially rectangular, substantially oblong shaped, or substantially elongated with approximately parallel-shaped sides in some example implementations when the lower mat and the upper mat are in an assembled configuration. The removable automobile mat assembly 100 may also be substantially rhomboidal in cross-section, which may lend itself to greater compatibility with a substantially flat floor surface, such as a floor bed of a vehicle. The upper mat 110 and lower mat 120 may include separate, bodies, which may be formed of any of a number of different materials. The body may be formed of any suitable, structurally-sound material. In some examples, the body may be formed of an elastomeric material, rubber press-stud material or a fibrous material or a combination thereof. Suitable fibrous materials include various polymer fibers, natural fibers and the like.

Various interlocking means may connect the lower mat 120 to the upper mat 110 to result in a threaded engagement, a press-fit engagement, an interference-fit engagement, a magnetic engagement or the like. Examples of interlocking means can include, but are not limited to, press-stud and press-stud receptacle engagement; magnetic engagement, nuts and bolts, and the like.

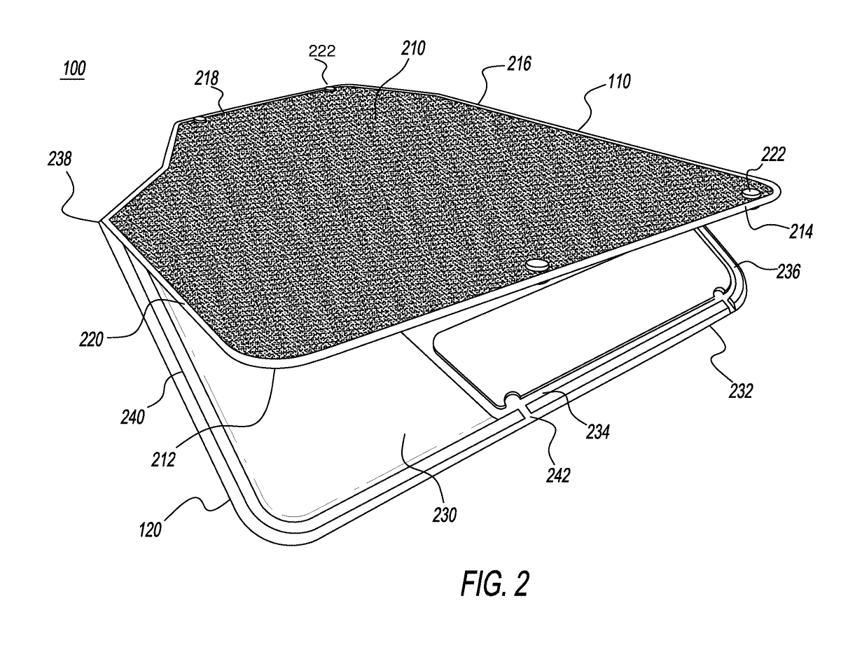

FIG. 2 more particularly illustrates the removable automobile mat assembly 100, in accordance with some example implementations. As seen in the view illustrated therein, again, the removable automobile mat assembly 100 can comprise an upper mat 110 and a lower mat 120 each of which include a number of respective features. The features illustrated in FIG. 2 are representative of the features that may be present in an upper mat 110 and lower mat 120 and are not intended to limit the scope of features that are encompassed by the present disclosure. As shown, for example, the upper mat 110 can be formed having a top surface 210, a bottom surface 212, a first side edge 214, a second side edge 216, a third side edge 218, and a fourth side edge 220. As shown in FIG. 2, the first side edge 214 and third side edge 218 may comprise an upper mat interlocking means 222. In another embodiment, the upper mat interlocking means 222 may alternatively be comprised along the first side edge 214 of the upper mat. In another embodiment, the upper mat interlocking means 222 may alternatively be comprised along a third side edge 218 of the upper mat. In yet another embodiment, the upper mat interlocking means 222 may be along the second side edge 216. In yet another embodiment, the upper mat interlocking means 222 may be along the fourth side edge 220. And in yet another embodiment, the upper mat interlocking means 222 may be long a first side edge 214, a second side edge 216, a third side edge 218, and a fourth side edge 220.

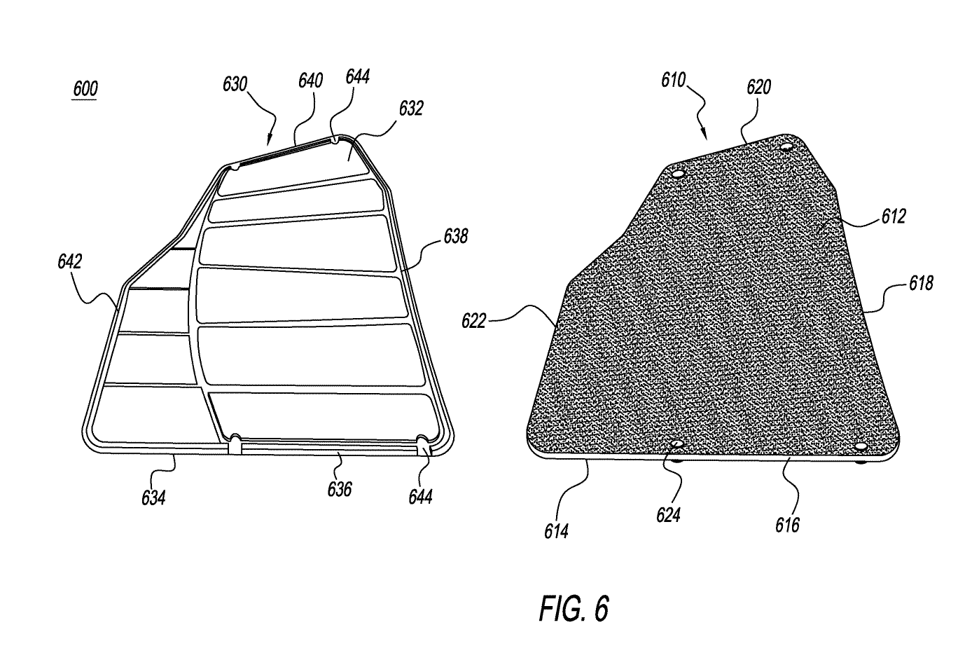

The lower mat 120 can be formed having a top surface 230, a bottom surface 232, a first side edge 234, a second side edge 236, a third side edge 238, and a fourth side edge 240. The first side edge 234, 636 and third side edge 238, 640 may comprise a lower mat interlocking means 242, as shown in FIGS. 2 and 6. In another embodiment, the lower mat interlocking means 242 may alternatively be comprised along the first side edge 234 of the lower mat. In another embodiment, the lower mat interlocking means 242 may alternatively be comprised along a third side edge 238 of the lower mat. In yet another embodiment, the lower mat interlocking means 242 may be along the second side edge 236. In yet another embodiment, the lower mat interlocking means 242 may be along the fourth side edge 240. And in yet another embodiment, the lower mat interlocking means 242 may be long a first side edge 234, a second side edge 236, a third side edge 238, and a fourth side edge 240.

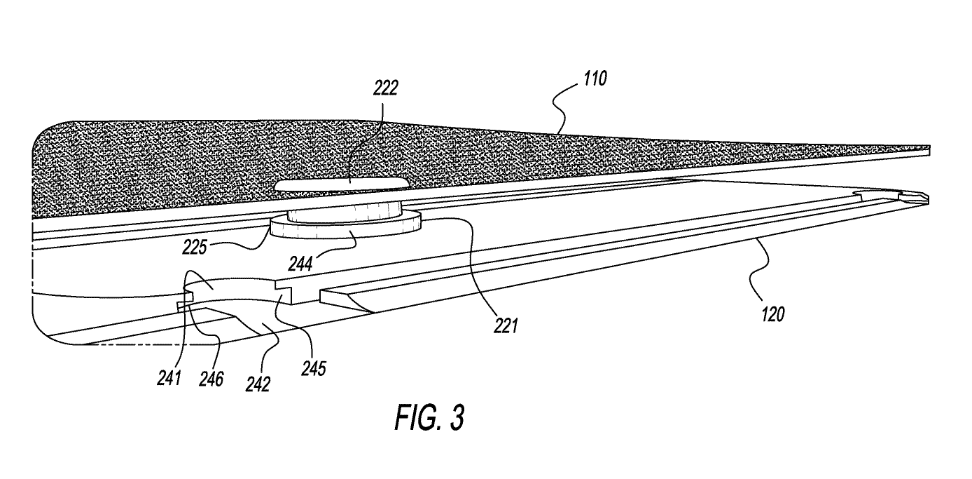

The upper mat 110 and the lower mat 120 may include components adapted to facilitate removable engagement therebetween. As illustrated in FIG. 3, the upper mat 110 can include an upper mat interlocking means 222 comprising a press-stud having a press-stud projection 221 therefrom. The lower mat interlocking means 242 can be adapted to engage the press-stud and press-stud projection 221, and can include a press-stud receptacle 241 having a cavity adapted to receive the press-stud projection 221. Such engagement can facilitate a stable connection between the upper mat 110 and the lower mat 120. Alternatively, an embodiment of the present invention can include the upper mat 110 configured having a press-stud receptacle 241 therein, and the lower mat 120 may be configured with a press-stud having a press-stud projection 221. In such an embodiment, the lower mat 120 can be adapted to engage the press-stud receptacle of the upper mat 110 to provide a functional, stable connection.

The press-stud receptacle 241 as seen in FIG. 3 may define a press-stud receptacle outer periphery 245 configured to mate with the press-stud projection inner periphery 225 along the press-stud projection 221. In one example the press-stud projection inner periphery 225 may define a radius that is substantially equal to, or slightly less than, a radius of the press-stud receptacle outer periphery 245. Further, the upper mat interlocking means 222 press-stud projection 221 may define one or more press-stud protrusions 244 at the outer periphery of the press-stud projection 221 configured to engage one or more press-stud receptacle recesses 246 defined along the inner periphery of the press-stud receptacle 241. However, various other examples of structures, shapes and components may be employed to couple the upper mat interlocking means 222 to the lower mat interlocking means 242. The connection between the upper mat interlocking means 222 and the lower mat interlocking means 242 may be substantially releasable and optionally, interchangeable such that, for example, the lower mat 120 may be reused with one or more additional upper mats 110 that may be dispensable.

Referring back to FIG. 2, the top surface 210 of the upper mat 110 can be a fibrous surface, as presently described. For example, the top surface of the upper mat can comprise one or more layers of fibers substantially forming a carpet structure. The top surface may trap contaminants such as dirt, debris and stains and any particulate matter, which may, for example, are of the type to adhere to shoes of a vehicle rider. Liquid components, for example, can flow through the carpet structure of the upper mat. The top surface 210 of the upper mat 110 can be in fluid communication with the lower mat 120. Example implementations of the top surface 210 of the upper mat 110 useful in removable automobile mats according to the present disclosure are further described below, and such the top surface 210 of the upper mat 110 can be incorporated into various articles such as illustrated in FIG. 2 as described herein.

The top surface 210 of the upper mat 110 may comprise a variety of materials including, for example, a machine washable fiber, a machine washable polymer fiber and washable natural fiber. The top surface of the upper mat 110 may detach from the lower mat 120 to clean in a washing machine. A user may detach the upper mat 110 from the lower mat 120 and place into a washing machine. These features save time and energy, as pressure washing or hosing down the automobile mat will no longer be necessary.

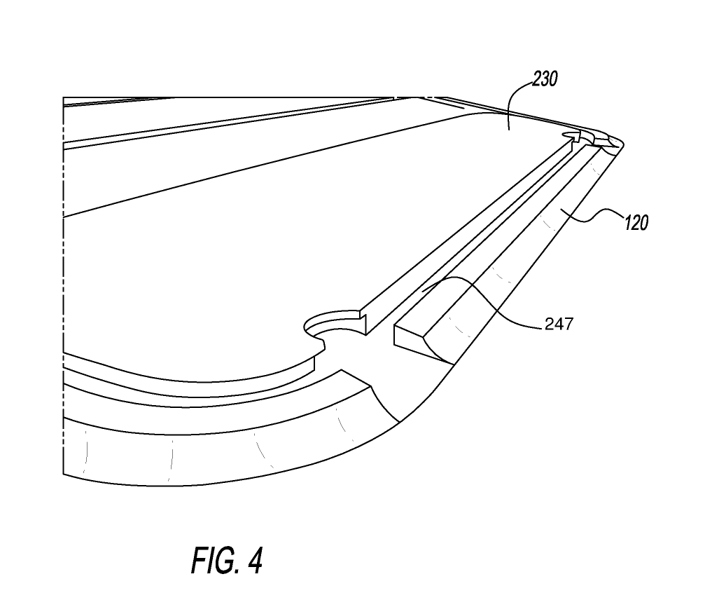

In some examples, the top surface 230 of the lower mat 120 may comprise a plurality of grooves 247, as shown in FIG. 4. While the grooves 247 illustrated are generally rectangular, it will be appreciated by those of reasonable skill in the art that other shapes may be used such as squares, triangles, or lines which are curvilinear. The grooves 247 may receive fluids and hold a substantial quantity. Also, in some examples, the top surface of the lower mat 120 may have a recess or grooves 247 along a portion or the entirety of the perimeter of the first side edge, the second side edge, the third side edge and the fourth side edge for holding a quantity of fluids.

In some examples, the bottom surface 212 of the upper mat 110 may comprise a semi-flexible material, such as rubber nibbing. In some embodiments, the bottom surface 232 of the lower mat 120 may comprise a flexible, semi-flexible, or rigid material such as for example, rubber, vinyl or thermoplastic and composites thereof.

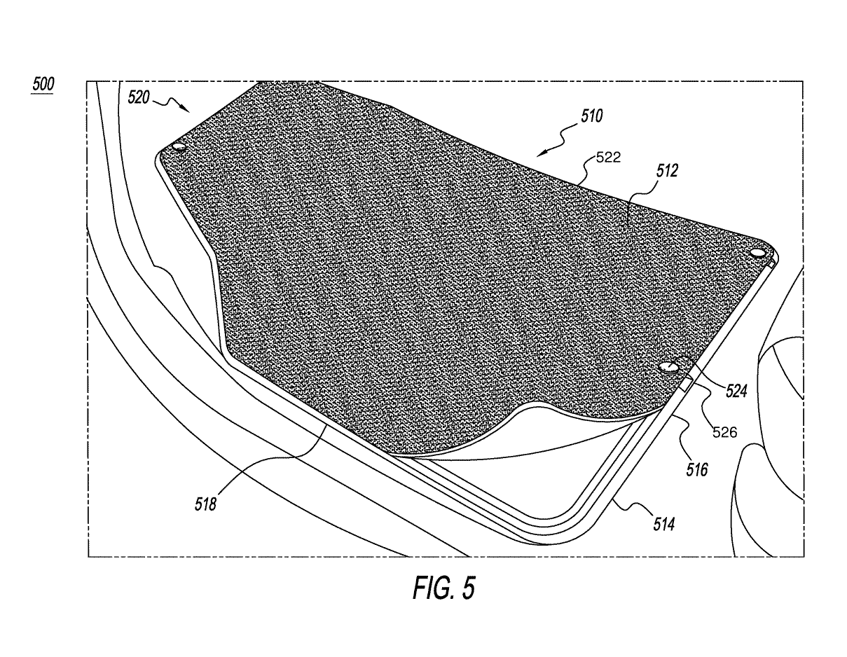

FIG. 5 illustrates the removable automobile mat assembly 500 as shown in use in an automobile or vehicle. The removable automobile mat assembly 500 may comprise an upper mat 510 having a top surface 512, a lower mat 514, and the assembly having a first side edge 516, a second side edge 518, a third side edge 520, and a fourth side edge 522. The first side edge 516 and third side edge 520 may comprise an interlocking means 524 (press-stud), 526 (press-stud receptacle) to removably interlock the upper mat 510 with the lower mat 514. The interlocking means can take on various implementations. In some embodiments, the interlocking means may comprise a press-stud configuration. In other examples, the interlocking means may comprise a threaded engagement, a press-fit engagement, an interference fit, a magnetic engagement and the like.

Additionally, the top surface 512 of the mat may comprise a machine washable fiber wherein the top surface 512 may be readily cleaned utilizing a washing machine. The machine washable fiber may include cotton, DACRON or similar polyethylene terephthalate compositions, polyester, rayon, polyester-cotton or DACRON-polyester combinations, nylon, and the like, or any other suitable machine washable fiber.

FIG. 6 illustrates, a removable automobile mat assembly kit 600. As shown, the removable automobile mat assembly kit may comprise an upper mat 610 and a lower mat 630. The upper mat may include a top surface 612, a bottom surface 614, a first side edge 616, a second side edge 618, a third side edge 620, and a fourth side edge 622. The first side edge 616 and third side edge 620 may comprise an upper mat interlocking means 624 to removably interlock the upper mat 610 with the lower mat 630. The lower mat 630 may include a top surface 632, a bottom surface 634, a first side edge 636, a second side edge 638, a third side edge 640, and a fourth side edge 642. The first side edge 636 and third side edge 640 of the lower mat 630 may comprise a lower mat interlocking means 644 to removably interlock the upper mat 610 with the lower mat 630. In yet another embodiment, lower mat interlocking means 644 may be incorporated along all for side edges, or along only one side, or any combination of side edges of the lower mat 630. Conversely, in yet another embodiment, upper mat interlocking means 624 may be incorporated along all for side edges, or along only one side, or any combination of side edges of the upper mat 610. The upper mat 610 and lower mat 630 are configured to be removably attach to one another, and the interlocking means can take on various implementations. In some embodiments, the upper mat interlocking means 624 may comprise a press-stud. In other examples, the lower mat interlocking means 644 may comprise a press-stud receptacle. In yet another embodiment, the upper mat interlocking means 624 may comprise a press-stud receptacle. And in yet another embodiment, lower mat interlocking means 644 may comprise a press-stud.

The foregoing description of use of the article(s) can be applied to the various example implementations described herein through minor modifications, which can be apparent to the person of skill in the art in light of the further disclosure provided herein. The above description of use, however, is not intended to limit the use of the article but is provided to comply with all necessary requirements of disclosure of the present disclosure. Any of the elements shown in the article(s) illustrated in FIGS. 1-6 or as otherwise described above may be included in a removable automobile mat, assembly, or kit according to the present disclosure.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A removable automobile mat assembly comprising:
an upper mat having a top surface, a bottom surface, a first side edge, a second side edge, a third side edge, and a fourth side edge, wherein said first side edge further comprises an upper mat interlocking means;
a lower mat having a top surface, a bottom surface, a first side edge, a second side edge, a third side edge, and a fourth side edge, wherein said first side edge comprises a lower mat interlocking means; and
wherein the upper mat and lower mat are configured to be removably attached to one another.

2. The removable mat assembly of claim 1, wherein the upper mat interlocking means comprises a press-stud.

3. The removable mat assembly of claim 1, wherein the lower mat interlocking means comprises a press-stud receptacle.

4. The removable mat assembly of claim 1, wherein the upper mat interlocking means comprises a press-stud receptacle.

5. The removable mat assembly of claim 1, wherein the lower mat interlocking means comprises a press-stud.

6. The removable mat assembly of claim 1, wherein the top surface of the lower mat further comprises a plurality of grooves.

7. The removable mat assembly of claim 1, wherein the top surface of the upper mat comprises machine washable fiber.

8. The removable mat assembly of claim 7, wherein the top surface of the upper mat further comprises machine washable polymer fiber.

9. The removable mat assembly of claim 7, wherein the top surface of the upper mat further comprises washable natural fiber.

10. The removable mat assembly of claim 1, wherein the top surface of the lower mat is formed having a recess along a perimeter of the first side edge, the second side edge, the third side edge and the fourth side edge.

11. The removable mat assembly of claim 1, wherein the bottom surface of the upper mat is comprised of semi-flexible material.

12. A removable automobile mat comprising:
a mat having a top surface, a bottom surface, a first side edge, a second side edge, a third side edge, and a fourth side edge, wherein said first side edge further comprises an interlocking means.

13. The removable mat of claim 12, wherein the interlocking means comprises a press-stud.

14. The removable mat of claim 12, wherein the interlocking means comprises a press-stud receptacle.

15. The removable mat of claim 12, wherein the top surface of the mat comprises machine washable fiber.

16. The removable mat of claim 12, wherein the top surface of the mat is comprised of semi-flexible material.

17. A removable automobile mat assembly kit comprising:
an upper mat having a top surface, a bottom surface, a first side edge, a second side edge, a third side edge, and a fourth side edge, wherein said first side edge further comprises an upper mat interlocking means; and
a lower mat having a top surface, a bottom surface, a first side edge, a second side edge, a third side edge, and a fourth side edge, wherein said first side edge comprises a lower mat interlocking means.

18. The removable automobile mat assembly kit of claim 17, wherein the upper mat and lower mat are configured to be removably attached to one another.

19. The removable automobile mat assembly kit of claim 17, wherein the upper mat interlocking means comprises a press-stud.

20. The removable automobile mat assembly kit of claim 17, wherein the lower mat interlocking means comprises a press-stud receptacle.
